(19) United States
(12) Patent Application Publication
(10) Pub. No.: US 2019/0164015 A1
(43) Pub. Date: May 30, 2019

(54) MACHINE LEARNING TECHNIQUES FOR EVALUATING ENTITIES

(71) Applicant: SIGMA RATINGS, INC., New York, NY (US)

(72) Inventors: Stuart Jones, JR., New York, NY (US); Gabrielle Haddad, New York, NY (US); Niger Little-Poole, Brooklyn, NY (US); Cole Page, Brooklyn, NY (US)

(21) Appl. No.: 16/202,785

(22) Filed: Nov. 28, 2018

Related U.S. Application Data
(60) Provisional application No. 62/591,478, filed on Nov. 28, 2017.

(51) Int. Cl. G06K 9/62; G06N 20/00; G06F 16/9035; G06F 16/906

(52) U.S. Cl. CPC G06K 9/6262; G06F 16/906; G06F 16/9035; G06N 20/00

(57) ABSTRACT

Systems, methods, apparatuses, and computer program products for evaluating and/or rating entities using machine learning techniques are provided. One method may include receiving, by a computer system, identifying information for an entity and collecting data relating to the entity from at least one of public data sources or private data sources. The method may further include determining and producing data that is actually relevant to the entity, and classifying the relevant data into different areas of risk associated with the entity. The method may also include using the relevant data, different areas of risk associated with the entity, and information regarding risk attributes of the entity to determine and assign, through an entity risk model, a risk score for the entity, and outputting the risk score for the entity to a device of an end user.

### CROSS-REFERENCE TO RELATED APPLICATIONS

This application claims priority from U.S. provisional patent application No. 62/591,478 filed on Nov. 28, 2017. The contents of this earlier filed application are hereby incorporated by reference in their entirety.

### FIELD

Some example embodiments may generally relate to machine learning. For example, certain embodiments may relate to systems and/or methods for evaluating and/or rating entities using machine learning techniques.

### BACKGROUND

Machine learning provides computer systems the ability to learn without being explicitly programmed. In particular, machine learning relates to the study and creation of algorithms that can learn and make predictions based on data. Such algorithms may follow programmed instructions, but can also make their own predictions or decisions based on data. In certain applications, machine learning algorithms may build a model from sample inputs. Accordingly, machine learning algorithms are able to make data-driven predictions or decisions, through the building of a model from sample inputs. Machine learning can be employed in an assortment of computing tasks where programming explicit algorithms with the desired performance results is difficult. Example applications may include email filtering, detection of network intruders, search engines, optical character recognition, and computer vision. However, the applications of machine learning are basically boundless.

### SUMMARY

One embodiment is directed to a method for evaluating and/or rating entities using machine learning. The method may include: receiving, by a computer system, identifying information for an entity; collecting, using the identifying information, data relating to the entity from at least one of public data sources or private data sources; determining, by a relevance model, a relevancy of the collected data to the entity; filtering the collected data based on the determined relevancy of the collected data to produce relevant data; classifying, by a classification model, the relevant data into different areas of risk associated with the entity; storing the relevant data and links between the relevant data in a knowledge graph; determining, from the relevant data, information regarding risk attributes of the entity; analyzing the relevant data, the different areas of risk associated with the entity, and the information regarding the risk attributes of the entity to determine and assign, through an entity risk model, a risk score for the entity; and outputting the risk score for the entity to a device of an end user.

Another embodiment is directed to an apparatus configured for evaluating and/or rating entities using machine learning. The apparatus may include at least one processor and at least one memory comprising computer program code. The at least one memory and computer program code may be configured, with the at least one processor, to cause the apparatus at least to: receive identifying information for an entity; collect, using the identifying information, data relating to the entity from at least one of public data sources or private data sources; determine, by a relevance model, a relevancy of the collected data to the entity; filter the collected data based on the determined relevancy of the collected data to produce relevant data; classify, by a classification model, the relevant data into different areas of risk associated with the entity; store the relevant data and links between the relevant data in a knowledge graph; determine, from the relevant data, information regarding risk attributes of the entity; analyze the relevant data, the different areas of risk associated with the entity, and the information regarding the risk attributes of the entity to determine and assign, through an entity risk model, a risk score for the entity; and output the risk score for the entity to a device of an end user.

Another embodiment is directed to an apparatus for evaluating and/or rating entities using machine learning. The apparatus may include means for receiving identifying information for an entity; means for collecting, using the identifying information, data relating to the entity from at least one of public data sources or private data sources; means for determining, by a relevance model, a relevancy of the collected data to the entity; means for filtering the collected data based on the determined relevancy of the collected data to produce relevant data; means for classifying, by a classification model, the relevant data into different areas of risk associated with the entity; means for storing the relevant data and links between the relevant data in a knowledge graph; means for determining, from the relevant data, information regarding risk attributes of the entity; means for analyzing the relevant data, the different areas of risk associated with the entity, and the information regarding the risk attributes of the entity to determine and assign, through an entity risk model, a risk score for the entity; and means for outputting the risk score for the entity to a device of an end user.

Another embodiment is directed to a computer program, embodied on a non-transitory computer readable medium, the computer program configured to control a processor to perform a process. The process may include: receiving, by a computer system, identifying information for an entity; collecting, using the identifying information, data relating to the entity from at least one of public data sources or private data sources; determining, by a relevance model, a relevancy of the collected data to the entity; filtering the collected data based on the determined relevancy of the collected data to produce relevant data; classifying, by a classification model, the relevant data into different areas of risk associated with the entity; storing the relevant data and links between the relevant data in a knowledge graph; determining, from the relevant data, information regarding risk attributes of the entity; analyzing the relevant data, the different areas of risk associated with the entity, and the information regarding the risk attributes of the entity to determine and assign, through an entity risk model, a risk score for the entity; and outputting the risk score for the entity to a device of an end user.

### BRIEF DESCRIPTION OF THE DRAWINGS

For proper understanding of example embodiments, reference should be made to the accompanying drawings, wherein:

FIG. 1 illustrates an example system diagram, according to one embodiment;

FIG. 2 illustrates an example flow diagram of a method, according to an embodiment; and

FIG. 3 illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for evaluating and/or rating entities using machine learning techniques, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

A credit rating refers to an assessment of the creditworthiness of a borrower in general terms or with respect to a particular debt or financial obligation. Such a credit rating may be assigned to any entity that seeks to borrow money, such as an individual, corporation, state, local authority, or sovereign government. Credit assessment and evaluation for companies and governments is generally performed by a credit rating agency which assigns credit ratings that rate a debtor's ability to pay back debt by making timely payments, as well as their likelihood of default. Credit rating agencies may also rate the creditworthiness of issuers of debt obligations, of debt instruments, and/or the servicers of the underlying debt.

The accuracy of credit ratings as a reflection of the actual risk of doing business with potential debtors or issuers is dubious, as there have been several examples of defaults and financial disasters not detected by traditional credit ratings. Further, there is currently no capability to automatically generate and monitor the risk associated with an entity. Therefore, there is a need for improving the manner in which companies and/or institutions are evaluated or rated.

Given the deficiencies in how corporations and institutions are rated, as discussed above, example embodiments provide an artificial intelligence and machine learning enabled method for evaluating and rating the credit risk and/or non-credit risk associated with companies or institutions.

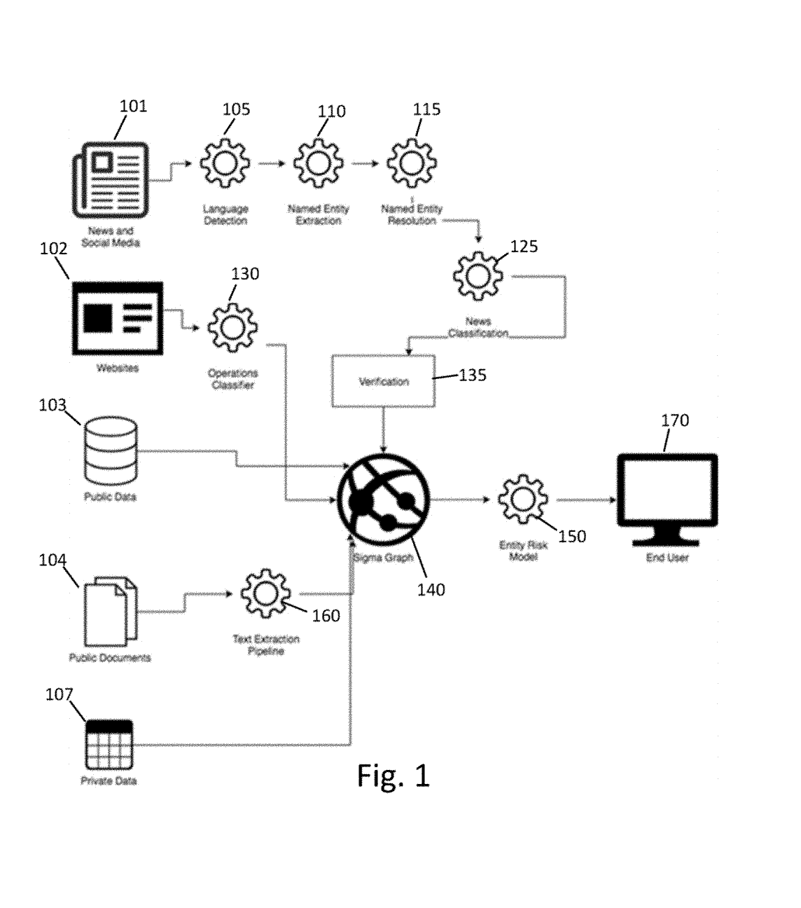

FIG. 1 illustrates an example system 100 configured to evaluate and/or rate entities using machine learning, according to example embodiments. For instance, in one embodiment, the system 100 may be configured to rate the non-credit risk associated with entities, such as companies, organizations, and/or financial institutions. In certain example embodiments, system 100 may be included in one or more computer systems that include one or more processors and/or memories.

In one embodiment, system 100 may be configured to receive or obtain identifying information for an entity, company, organization or institution, such as a financial institution or bank. For example, the identifying information may include the name of the entity, a tax identifier of the entity, a company registration number, a Global Intermediary Identification Number (GIIN) of the entity, a SWIFT code for the institution, or other identifier. According to an embodiment, system 100 may be further configured to collect, using the identifying information, data relating to the entity from public data sources, such as news or social media sources 101 (e.g., news articles, reports, or social media sites), a corporate website 102, public data sources 103, and/or publicly available documents 104 (e.g., annual reports or financial reports). According to certain embodiments, system 100 may be configured to automatically collect the data or to semi-automatically collect the data, for example. In some example embodiments, system 100 may be configured to automatically collect the data using web crawlers purposely built to crawl news, social media sites, documents or other datasets from the public internet. In one embodiment, system 100 may also be configured to collect private data 107 that may be obtained directly from the entity or its representatives, for example. In another embodiment, the private data 107 may be obtained from industry experts or people knowledgeable of the entity or the market collected via automated and non-automated means (e.g., surveys, interviews, etc.), for instance.

In certain embodiments, system 100 may input the collected data into a language detection model 105 configured to classify the language(s) used within a corpus of text of the obtained data (e.g., article, document, report, etc.). According to one example embodiment, the language detection model 105 may be a deep learning method, for example, based on learning data representations. The deep learning method of the language detection model 105 may be supervised, semi-supervised or unsupervised, according to some example embodiments. In an embodiment, the language detection model 105 may be trained with new data to enhance the accuracy of the language detection.

According to an embodiment, system 100 may input the collected data (that may have or may have not been processed through the language detection stage 105) into a named entity recognition model 110 that is configured to identify, from the collected data, information including people, companies, countries and/or geographical regions that are relevant to the entity. According to one example embodiment, the named entity recognition model 110 may be a clustering or cluster analysis method that may group the recognized information or objects such that objects in the same group (i.e., cluster) are more similar to each other than to those in other groups (clusters).

In certain embodiments, system 100 may be configured to input the identified information from the named entity recognition stage 110 into a named entity resolution model 115 that is configured to automatically link or map the identified information with other identified information extracted from the entity recognition stage 110 or stored in a knowledge graph 140.

According to one embodiment, system 100 may also include a content relevance model that may be configured to determine the relevancy of a given news article or social media content 101, or the relevancy of other content (e.g., from websites 102, public data 103, public documents 104, private data 107), to the named entity (e.g., company, organization or institution at hand) The content relevance model is able to automatically inform or teach system 100 as to whether the entity was simply mentioned in the article or if the entity was actually the main subject of the article. For instance, the content relevance model may utilize factors such as the source of the article or report, the location of the article's publisher or author, or other such factors to determine whether an article or report is actually relevant to the entity. Then, in an embodiment, system 100 may be configured to filter all of the collected data through the content relevance model to produce data relevant to the entity.

In one example embodiment, system 100 may also include a news classification model 125 that is configured to classify relevant data about entities (e.g., the relevant data may include companies, organizations, institutions, financials, personnel, regulatory issues, etc.) into different areas of risk. For example, the different areas of risk may include one or more of regulatory risk, reputational risk, financial crime risk, control risk, cybersecurity risk, governance risk, environmental risk, and/or geopolitical risk. According to certain embodiments, the news classification model 125 may classify general themes, as well as identify key events that, while not necessarily having positive or negative sentiment, can materially change the risk in an entity. Some non-limiting examples of a key event may include the changing of a board member or the release of a new product by a company.

According to some embodiments, the news classification model 125 may be further configured to classify relevant data (e.g., news media, articles, reports, social media, etc.) about countries into different areas of risk. The classification model 125 goes beyond mere sentiment analysis to automatically classify articles into nuanced buckets or classifications, such as corruption, regulatory events, money laundering, hacking, as some examples. This enhanced level of classification allows system 100 to produce a more accurate result (e.g., risk rating).

According to an example embodiment, system 100 may further include an operations classifier model 130 configured to identify key operational risk attributes from public data sources, such as a corporate website. In some embodiments, the operations classifier model 130 may also be configured to identify key operational risk attributes from other data sources, such as public data 103, public documents 104 and/or private data 107. These key operational risk attributes may include, but are not limited to, the locations of company offices and/or the products or services offered by the entity.

In some embodiments, system 100 may also include a verification platform 135 configured to allow analysts to verify at least some of the outputs of the news classification model 125. The verified outputs or data points may then be used to retrain any of the models described herein. In an embodiment, the models may be periodically (e.g., daily) retrained to improve the accuracy of the models and system 100 and to prevent false negatives or false positives.

In an embodiment, system 100 may be configured to determine, from the relevant data, information regarding risk attributes of the entity. For example, the risk attributes may include attributes relating to the operations, governance, and/or reputation of the entity. According to one embodiment, system 100 may also include an entity risk model 150 configured to analyze the relevant data, the different areas of risk associated with the entity, and the information regarding the risk attributes of the entity to determine and assign a risk score (e.g., a non-credit risk score) for the entity. According to some embodiments, the entity risk model 150 may be configured to determine the risk score using observable risk attributes or factors associated with the entity, such as products, geography, ownership, management/board, operations, reputation, transparency, cybersecurity, as well as other risk including, e.g., client risk, revenue breakdown, etc. Also, in an embodiment, the entity risk model 150 may be configured to determine the risk score using non-observable risk attributes, such as compliance management, independent testing, training, culture, proactiveness, and/or strategy of the entity.

In an embodiment, the entity risk model 150 may also be configured to determine a country risk rating, for example, based on non-linear methodologies. For example, the risk model 150 may take static country data (e.g., World Bank data, GDP, etc.) and/or dynamic data (news sentiment, digital currency transactions, etc.) to generate a non-credit risk rating for every nation in the world. The importance or priority of each piece of data or rating may be determined via machine learning and translated. According to some embodiments, system 100 may be configured to output the risk score (e.g., a non-credit risk score) for the entity and/or the risk score for the countries to a device of an end user 170.

According to some example embodiments, system 100 may be configured to verify at least a portion of the output of the entity risk model 150 (or any of the other models described herein) to produce verified data points. In an embodiment, system 100 may also be configured to train the entity risk model 150 (or other models) using the verified data points to improve the accuracy of the output of the entity risk model 150. According to certain embodiments, the entity risk model 150 may be any model capable of outputting numerical scores. For example, in an embodiment, the entity risk model 150 may be a decision tree machine-learning model that uses a decision tree as a predictive model.

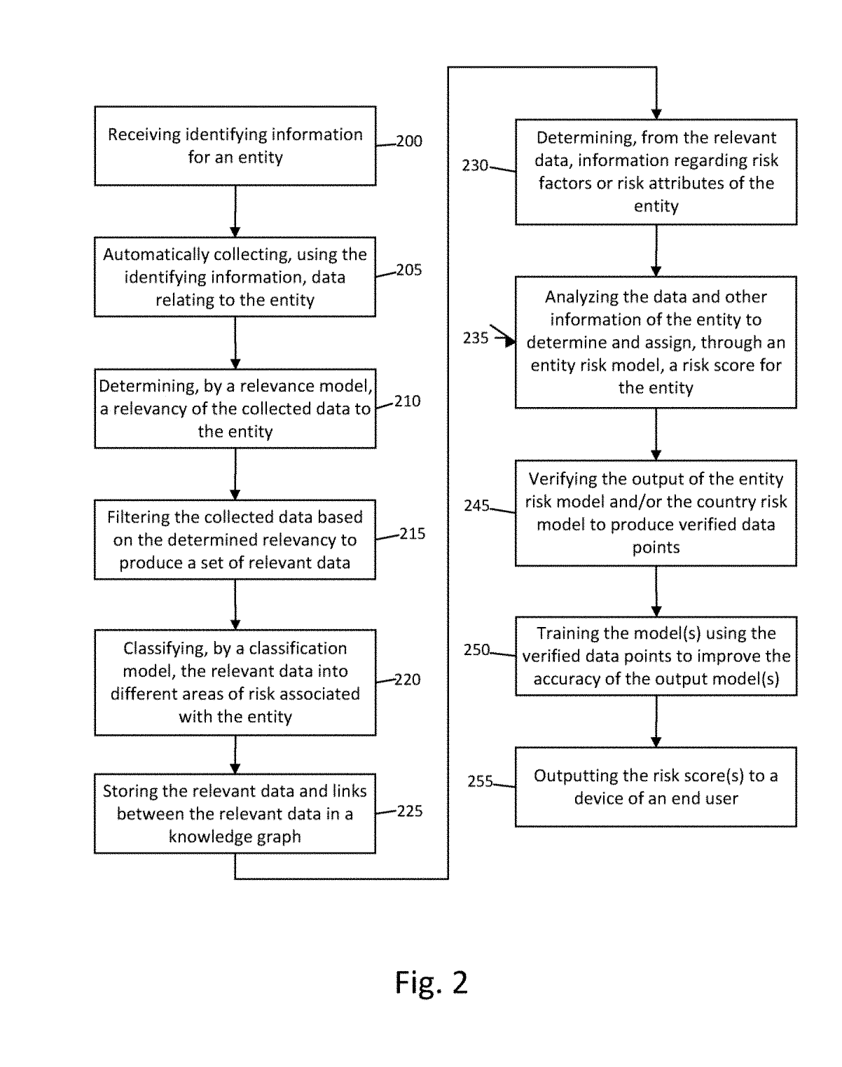

FIG. 2 illustrates an example flow diagram of a method for evaluating and/or rating entities using machine learning, according to an example embodiment. In some example embodiments, the method of FIG. 2 may be performed by a computer system or server including one or more processors and/or one or more memories. It should be noted that the steps depicted in the example flow diagram of FIG. 2 may be performed in a different order than shown herein.

As illustrated in the example of FIG. 2, the method may include, at 200, receiving identifying information for an entity. For example, the entity may include, but is not limited to, a company, organization, and/or institution, such as a financial institution or bank. In an example embodiment, the identifying information a name of the entity and/or another identifier of the entity, such as a tax identifier of the entity, a company registration number, a Global Intermediary Identification Number (GIIN) of the entity, a SWIFT code for the institution, or other identifier. The method may also include, at 205, collecting, using the identifying information, data relating to the entity from public data sources and/or private data sources. In some embodiments, the collecting 205 may include automatically collecting the data or semi-automatically collecting the data. According to one example, the public data sources may include, but is not limited to, news articles, reports, websites, or other publicly available information. According to certain embodiments, the collecting 205 may further include receiving private data from the entity or from an authorized representative of the entity, for example. In one example embodiment, the method may also include detecting or classifying languages used within a text of the collected data.

As further illustrated in the example of FIG. 2, the method may also include, at 210, determining, by a relevance model, a relevancy of the collected data to the entity. In one example, the relevance model may include a machine learning algorithm or mathematical model stored in at least one memory and executed by at least one processor. In an embodiment, the method may then include, at 215, filtering the collected data based on the determined relevancy of the collected data to produce a set of relevant data. According to certain embodiments, the method may further include, at 220, classifying, by a classification model, the relevant data into different areas of risk associated with the entity. In one example, the classification model may include a machine learning algorithm or mathematical model stored in at least one memory and executed by at least one processor. According to an embodiment, the classifying 220 may further include identifying key events that may materially change the risk associated with the entity. In some embodiments, the method may also include, at 225, storing the relevant data and links between the relevant data in a knowledge graph. According to an embodiment, the storing 225 may further include storing information representing the people, companies, nations and/or geographical regions that are relevant to the entity and the links between them in the knowledge graph.

According to certain example embodiments, the method of FIG. 2 may also include, at 230, determining, from the relevant data, information regarding risk factors or risk attributes of the entity, such as operations, governance, and/or reputation of the entity. The method may further include, at 235, analyzing the relevant data, the different areas of risk associated with the entity, and the information regarding the risk factors or attributes (e.g., the operations, governance, and/or reputation) of the entity to determine and assign, through an entity risk model, a risk score for the entity. In one example, the risk score may include a non-credit risk score and/or credit risk score. According to some embodiments, the entity risk model may include a machine learning algorithm or mathematical model stored in at least one memory and executed by at least one processor. For example, in one embodiment, the entity risk model may be a decision tree machine-learning model.

In some example embodiments, the method may also include generating, by the entity risk model, a non-credit risk rating and/or credit risk rating for every country in the world using static country data and/or dynamic data. Then, in one example, the risk rating for one or more of the countries may be incorporated into the risk score determined by the entity risk model, where appropriate. According to an embodiment, the method may further include, at 245, verifying the output of the entity risk model to produce verified data points and, at 250, training the entity risk model using the verified data points to improve the accuracy of the output of the entity risk model and/or country risk model. In an embodiment, the method may also include identifying, by a relationship model, a relationship between one or more entities based on the collected data. According to certain embodiments, the method may include, at 255, outputting the risk score for the entity and/or the risk score for the countries to a device of an end user.

According to some example embodiments, the method may also include identifying, by an operations classifier model, key operational risk attributes from a website of the entity and/or from other public data sources. In one example embodiment, the method may further include identifying from the collected data, by a knowledge graph based recognition model, people, companies, nations and/or geographical regions that are relevant to the entity. For instance, in an embodiment, the relationship model may be configured to identify, from the collected data, the relationship(s) between people, companies, nations and/or geographical regions associated with the entity, and to store those identified relationships in the knowledge graph.

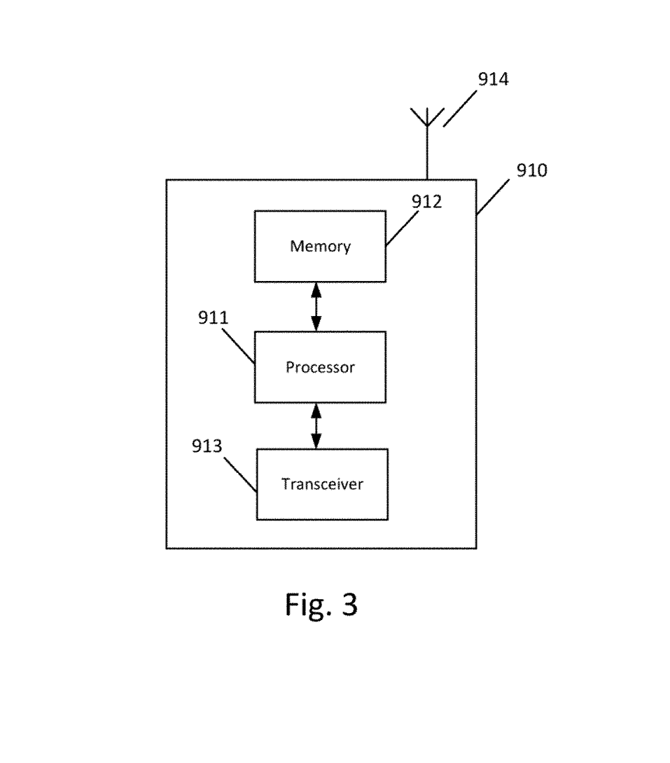

FIG. 3 illustrates an example block diagram of an apparatus 910, according to certain example embodiments. In the example of FIG. 3, apparatus 910 may include, for example, a computing device or server. Certain embodiments may include more than one computing device or server, although only one is shown for the purposes of illustration. The apparatus 910 may be included in system 100 of FIG. 1 or vice versa.

In an embodiment, apparatus 910 may include at least one processor or control unit or module, indicated as 911 in the example of FIG. 3. Processor 911 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

According to an embodiment, apparatus 910 may also include at least one memory 912. Memory 912 may be any suitable storage device, such as a non-transitory computer-readable medium. For example, memory 912 may be a hard disk drive (HDD), random access memory (RAM), flash memory, or other suitable memory may be used. The memory 912 may include or store computer program instructions or computer code contained therein. In some embodiments, apparatus 910 may include one or more transceivers 913 and/or an antenna 914. Although only one antenna each is shown, many antennas and multiple antenna elements may be provided. Other configurations of apparatus 910 may be provided. For example, apparatus 910 may be additionally configured for wired or wireless communication. In some examples, antenna 914 may illustrate any form of communication hardware, without being limited to merely an antenna.

Transceiver 913 may be a transmitter, a receiver, or both a transmitter and a receiver, or a unit or device that may be configured both for transmission and reception. The operations and functionalities may be performed in different entities, such as nodes, hosts or servers, in a flexible manner.

The apparatus 910 may be any combination of hardware that includes at least a processor and a memory. For example, the computing device may include one or more servers (e.g., application server, web server, file server or the like), and/or one or more computers or computing devices. In some embodiments, the computing device may be provided with wireless capabilities.

In certain embodiments, apparatus 910 may include means for carrying out embodiments described above in relation to FIGS. 1 or 2. In certain embodiments, at least one memory including computer program code can be configured to, with the at least one processor, cause the apparatus at least to perform any of the processes or embodiments described herein. For instance, in one embodiment, memory 912 may store one or more of the models illustrated in FIG. 1 for execution by processor 911.

According to certain embodiments, memory 912 including computer program code may be configured, with the processor 911, to cause the apparatus 910 at least to receive identifying information for an entity. For example, the entity may include, but is not limited to, a company, organization, and/or institution, such as a financial institution or bank. In an example embodiment, the identifying information a name of the entity and/or another identifier of the entity, such as a tax identifier of the entity, a company registration number, a Global Intermediary Identification Number (GIIN) of the entity, a SWIFT code for the institution, or other identifier.

In an embodiment, apparatus 910 may be controlled by memory 912 and processor 911 to automatically and/or semi-automatically collect, using the identifying information, data relating to the entity from public data sources and/or private data sources. According to one example, the public data sources may include, but are not limited to, news articles, reports, websites, or other publicly available information. According to certain embodiments, apparatus 910 may be controlled by memory 912 and processor 911 to receive private data from the entity or from an authorized representative of the entity, for example. In one example embodiment, apparatus 910 may also be controlled by memory 912 and processor 911 to detect or classify languages used within a text of the collected data.

In an embodiment, apparatus 910 may be controlled by memory 912 and processor 911 to determine, by a relevance model stored in memory 912, a relevancy of the collected data to the entity. In one example, the relevance model may include a machine learning algorithm or mathematical model stored in at least one memory and executed by at least one processor. In an embodiment, apparatus 910 may be controlled by memory 912 and processor 911 to filter the collected data based on the determined relevancy of the collected data to produce a set of relevant data. According to certain embodiments, apparatus 910 may be controlled by memory 912 and processor 911 to classify, by a classification model stored in the memory 912, the relevant data into different areas of risk associated with the entity. In one example, the classification model may include a machine learning algorithm or mathematical model stored in at least one memory and executed by at least one processor.

According to an embodiment, apparatus 910 may be controlled by memory 912 and processor 911 to identify key events that may materially change the risk associated with the entity. In some embodiments, apparatus 910 may be controlled by memory 912 and processor 911 to store the relevant data and links between the relevant data in a knowledge graph. According to an embodiment, apparatus 910 may be controlled by memory 912 and processor 911 to store information representing the people, companies, nations and/or geographical regions that are relevant to the entity and the links between them in the knowledge graph.

According to certain example embodiments, apparatus 910 may be controlled by memory 912 and processor 911 to determine, from the relevant data, information regarding risk factors or attributes of the entity, such as operations, governance, and/or reputation of the entity. In one embodiment, apparatus 910 may be controlled by memory 912 and processor 911 to analyze the relevant data, the different areas of risk associated with the entity, and the information regarding the risk factors or attributes (e.g., the operations, governance, and/or reputation) of the entity to determine and assign, through an entity risk model stored in the memory 912, a risk score for the entity. In one example, the risk score may include a non-credit risk score and/or credit risk score. According to some embodiments, the entity risk model may include a machine learning algorithm or mathematical model stored in at least one memory and executed by at least one processor. For example, in one embodiment, the entity risk model may be a decision tree machine-learning model.

In some example embodiments, apparatus 910 may be controlled by memory 912 and processor 911 to generate, by the entity risk model stored in the memory 912, a non-credit and/or credit risk rating for every country in the world using static country data and/or dynamic data. According to an embodiment, apparatus 910 may be controlled by memory 912 and processor 911 to verify the output of the entity risk model to produce verified data points, to train the entity risk model using the verified data points to improve the accuracy of the output of the entity risk model and/or country risk model. According to certain embodiments, apparatus 910 may be controlled by memory 912 and processor 911 to output the risk score for the entity and/or the risk score for the countries to a device of an end user.

According to some example embodiments, apparatus 910 may be controlled by memory 912 and processor 911 to identify, by an operations classifier model stored in the memory 912, key operational risk attributes from a website of the entity and/or from other public data sources. In one example embodiment, apparatus 910 may be controlled by memory 912 and processor 911 to identify from the collected data, by a knowledge graph based recognition model stored in the memory 912, people, companies, nations and/or geographical regions that are relevant to the entity. For instance, in an embodiment, the relationship model may be configured to identify, from the collected data, the relationship(s) between people, companies, nations and/or geographical regions associated with the entity, and to store those identified relationships in the knowledge graph.

Therefore, certain example embodiments provide several technical improvements, enhancements, and/or advantages. Certain embodiments provide methods for improving the accuracy and efficiency of machine learning algorithms or models running on a computer system. For example, certain embodiments improve the ability and accuracy of machines or computers to parse and/or filter data to determine the content that is relevant to certain target entities. Furthermore, some embodiments result in methods that provide an improved machine learning approach for predicting and rating the risk associated with certain entities. Accordingly, the use of certain example embodiments results in a technical improvement to computer functionality.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out some example embodiments. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 910), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the example embodiments as discussed above may be practiced with steps in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments. In order to determine the metes and bounds of the example embodiments, therefore, reference should be made to the appended claims.

We claim:

1. A method for evaluating entities using machine learning, the method comprising:
receiving, by a computer system, identifying information for an entity;
collecting, using the identifying information, data relating to the entity from at least one of public data sources or private data sources;
determining, by a relevance model, a relevancy of the collected data to the entity;
filtering the collected data based on the determined relevancy of the collected data to produce relevant data;
classifying, by a classification model, the relevant data into different areas of risk associated with the entity;
storing the relevant data and links between the relevant data in a knowledge graph;
determining, from the relevant data, information regarding risk attributes of the entity;
analyzing the relevant data, the different areas of risk associated with the entity, and the information regarding the risk attributes of the entity to determine and assign, through an entity risk model, a risk score for the entity; and
outputting the risk score for the entity to a device of an end user.

2. The method according to claim 1, further comprising:
verifying at least a portion of the output of the entity risk model to produce verified data points; and
training the entity risk model using the verified data points to improve the accuracy of the output of the entity risk model.

3. The method according to claim 1, further comprising identifying, by a relationship model, a relationship between one or more entities based on the collected data.

4. The method according to claim 1, wherein the entity risk model comprises a decision tree machine-learning model.

5. The method according to claim 1, further comprising identifying, by an operations classifier model, key operational risk attributes from a website of the entity or from other public data sources.

6. The method according to claim 1, wherein the classifying further comprises identifying key events that materially change the risk associated with the entity.

7. The method according to claim 1, further comprising detecting or classifying languages used within a text of the collected data.

8. The method according to claim 1, further comprising identifying from the collected data, by a knowledge graph based recognition model, people, companies, nations and/or geographical regions that are relevant to the entity.

9. The method according to claim 1, wherein the storing further comprises storing information representing the people, companies, nations and/or geographical regions that are relevant to the entity and the links between them in the knowledge graph.

10. The method according to claim 1, wherein the identifying information comprises at least one of a name of the entity or another identifier of the entity.

11. The method according to claim 1, wherein the entity comprises at least one of a company, organization, or institution.

12. The method according to claim 1, wherein the public data sources comprise at least one of news articles, reports, websites, or other publicly available information.

13. The method according to claim 1, wherein the collecting further comprises receiving private data from the entity or from an authorized representative of the entity.

14. An apparatus, comprising:
at least one processor; and
at least one memory comprising computer program code,
the at least one memory and computer program code configured, with the at least one processor, to cause the apparatus at least to
receive identifying information for an entity;
collect, using the identifying information, data relating to the entity from at least one of public data sources or private data sources;
determine, by a relevance model, a relevancy of the collected data to the entity;
filter the collected data based on the determined relevancy of the collected data to produce relevant data;
classify, by a classification model, the relevant data into different areas of risk associated with the entity;
store the relevant data and links between the relevant data in a knowledge graph;
determine, from the relevant data, information regarding risk attributes of the entity;
analyze the relevant data, the different areas of risk associated with the entity, and the information regarding the risk attributes of the entity to determine and assign, through an entity risk model, a risk score for the entity; and
output the risk score for the entity to a device of an end user.

15. The apparatus according to claim 14, wherein the at least one memory and the computer program code are further configured, with the at least one processor, to cause the apparatus at least to:
verify at least a portion of the output of the entity risk model to produce verified data points; and
train the entity risk model using the verified data points to improve the accuracy of the output of the entity risk model.

16. The apparatus according to claim 14, wherein the at least one memory and the computer program code are further configured, with the at least one processor, to cause the apparatus at least to identify, by a relationship model, a relationship between one or more entities based on the collected data.

17. The apparatus according to claim 14, wherein the entity risk model comprises a decision tree machine-learning model.

18. The apparatus according to claim 14, wherein the at least one memory and the computer program code are further configured, with the at least one processor, to cause the apparatus at least to identify, by an operations classifier model, key operational risk attributes from a website of the entity or from other public data sources.

19. The apparatus according to claim 14, wherein the at least one memory and the computer program code are further configured, with the at least one processor, to cause the apparatus at least to identify key events that materially change the risk associated with the entity.

20. The apparatus according to claim 14, wherein the at least one memory and the computer program code are further configured, with the at least one processor, to cause the apparatus at least to detect or classify languages used within a text of the collected data.

21. The apparatus according to claim 14, wherein the at least one memory and the computer program code are further configured, with the at least one processor, to cause the apparatus at least to identify from the collected data, by a knowledge graph based recognition model, people, companies, nations and/or geographical regions that are relevant to the entity.

22. The apparatus according to claim 14, wherein the at least one memory and the computer program code are further configured, with the at least one processor, to cause the apparatus at least to store information representing the people, companies, nations and/or geographical regions that are relevant to the entity and the links between them in the knowledge graph.

23. The apparatus according to claim 14, wherein the identifying information comprises at least one of a name of the entity or another identifier of the entity.

24. The apparatus according to claim 14, wherein the entity comprises at least one of a company, organization, or institution.

25. The apparatus according to claim 14, wherein the public data sources comprise at least one of news articles, reports, websites, or other publicly available information.

26. The apparatus according to claim 14, wherein the collecting further comprises receiving private data from the entity.

27. A computer program, embodied on a non-transitory computer readable medium, the computer program configured to control a processor to perform a process, comprising:
receiving identifying information for an entity;
collecting, using the identifying information, data relating to the entity from at least one of public data sources or private data sources;
determining, by a relevance model, a relevancy of the collected data to the entity;
filtering the collected data based on the determined relevancy of the collected data to produce relevant data;
classifying, by a classification model, the relevant data into different areas of risk associated with the entity;
storing the relevant data and links between the relevant data in a knowledge graph;
determining, from the relevant data, information regarding risk attributes of the entity;
analyzing the relevant data, the different areas of risk associated with the entity, and the information regarding the risk attributes of the entity to determine and assign, through an entity risk model, a risk score for the entity; and
outputting the risk score for the entity to a device of an end user.
